(19) United States
(12) Patent Application Publication
(10) Pub. No.: US 2004/0038084 A1
(43) Pub. Date: Feb. 26, 2004

(54) Engine component with wear-resistant coating

(76) Inventors: Robert Aharonov, West Bloomfield, MI (US); Raymond Fontana, Waldwick, NJ (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/645,972

(22) Filed: Aug. 22, 2003

Related U.S. Application Data
(60) Provisional application No. 60/405,557, filed on Aug. 23, 2002.

(51) Int. Cl. B32B 9/00

(52) U.S. Cl. 428/698; 428/469; 427/248.1

(57) ABSTRACT

A piston assembly for an internal combustion engine has at least a portion of a contact surface of the piston pin and/or connecting rod coated with a high hardness, lubricious coating. Some disclosed coatings include carbides, nitrides, oxynitrides, carbonitrides and sulfides of transition metals. Chromium nitride is one specifically disclosed coating material. Also disclosed are methods for preparing the coatings.

### RELATED APPLICATION

This application claims priority of U.S. Provisional Patent Application Serial No. 60/405,557 filed Aug. 23, 2002, entitled “Engine Component with Wear-Resistant Coating”, which is incorporated herein by reference.

### FIELD OF THE INVENTION

This invention relates generally to internal combustion engines. More specifically, the invention relates to internal combustion engines which manifest decreased friction and increased service life. Most specifically, the invention relates to internal combustion engines wherein a vapor deposited coating is provided on at least some of the surfaces thereof which are in sliding contact.

### BACKGROUND OF THE INVENTION

Friction has an adverse impact on the performance and service life of an internal combustion engine. Friction will decrease the operational efficiency of an engine and also cause wear, which will decrease the service life of the engine. Consequently, many efforts have been made to reduce the friction in internal combustion engines. Toward that end, components of engines are generally lubricated with liquid and semisolid materials such as oils and greases as well as with solid materials such as graphite or molybdenum disulfide. While such materials do function to reduce engine friction, their use requires that a steady supply of the materials be provided to the contacting surfaces of the engine. Physical conditions such as high temperatures and pressures can make delivery of such lubricant materials difficult. In addition, physical constraints on the engine such as the size of lubricating passages and clearances between mating parts can also complicate the delivery of lubricant materials. Consequently, the art has made attempts to dispose coatings of lubricious materials onto engine components during the manufacturing process. Such coatings are preferably hard, durable and lubricious. Unfortunately, these parameters are often mutually exclusive. Highly lubricious coatings tend to be soft and are readily worn away, while hard coatings tend to be abrasive and can actually increase internal friction in an engine.

The present invention provides a hard, lubricious coating which can be readily disposed on various components of an internal combustion engine. As will be explained hereinbelow, the materials and the methods of the present invention may be used with particular advantage for coating piston pins and/or associated connecting rods.

### SUMMARY OF THE INVENTION

The present invention provides materials and methods for coating various components of an internal combustion engine such that friction between contacting surfaces is reduced. The invention comprises a low friction coating disposed on a portion of a surface of an engine component. The low friction coating is preferably vapor deposited on the surface of the engine component. Most preferably, the coating is formed of a compound of metal selected from the group of metals consisting of carbides, nitrides, oxynitrides, carbonitrides, sulfides, and mixtures thereof.

### DETAILED DESCRIPTION OF THE INVENTION

In accord with the present invention, components of an internal combustion engine are coated with a durable lubricious material comprising a metallic compound, which compound is a nitride, carbide, oxynitride, carbonitride, sulfide, or mixture of the foregoing. Most preferably, the compound is a compound of a group IVA-VIA metal. For purposes of clarity, we note that there are various conventions for designating the groups of the periodic table; and as used herein, these referenced groups refer to the transition metals with group IVA being the titanium group metals, group VA being the vanadium group metals, and group VIA being the chromium group metals.

Some specifically preferred compounds used in the present invention include chromium nitride and molybdenum disulfide. In a specifically preferred embodiment of the invention, the coating is a coating of chromium nitride which may, optionally, be doped with other materials. In certain specific embodiments of the invention, the coating is polished so as to decrease its surface roughness. Polishing may be readily implemented by abrasive techniques and electro polishing techniques well known in the art.

The coatings of the present invention are preferably deposited onto the components of an engine by a vapor deposition process. As is known in the art, vapor deposition processes are typically carried out at pressures ranging from atmospheric to subatmospheric, and can be used to deposit a variety of materials in layers of controlled thickness onto a variety of substrates. Some vapor deposition processes which may be employed in the present invention are physical vapor deposition processes such as reactive and nonreactive sputtering, evaporation, chemical vapor deposition processes, plasma assisted chemical vapor deposition processes, arc vapor deposition, and various hybrid processes of the foregoing.

In one illustrative example, piston pins that are used to join pistons to connecting rods in internal combustion engines are coated with the materials of the present invention, and it has been found that the presence of these coatings greatly decreases the wear rate of the piston pins thereby enhancing the service life of the engine.

Prior to coating, however, the pins are cleaned in a water-based cleaning line. It is appreciated that those skilled in the art may become aware of various methods for cleaning the piston pins which differ from the method provided herein. Accordingly, the following cleaning process is merely exemplary of a preferred method comprising the steps of ultrasonically cleaning the pins in 20% Soak 2000 for several minutes, preferably 7 minutes. Thereafter, the pins are rinsed with de-ionized water for several seconds, preferably 30 seconds. Next, the pins are ultrasonically cleaned a second time in 4% Contrad 70 for 15 minutes and thereafter rinsed for 30 seconds in de-ionized water. After the above steps, the pins are subjected to a three-step rinse process in a de-ionized water 3-cascade tank for 30 seconds at each of the three steps. Finally, water droplets are blew off the pins using compressed air and then the pins are exposed to hot air drying for several minutes, preferably 15 minutes, before being ready for coating. Alternative methods for cleaning the pins may involve the use of a solvent such as acetone or Lotoxane with results equal to those from the water-based cleaning. During cleaning and coating, the pins are preferably fixed vertically using rods that hold the pins in a kicked planetary fixture.

One specifically preferred coating comprises chromium nitride, and a polished chromium nitride coating is a particularly preferred coating. Typical thicknesses for the coatings are in the range of 3-10 microns; and in a specific embodiment, the coating has an average thickness of 5 microns. The coatings may be deposited as a single layer, or as a plurality of layers. In some embodiments, layered structures of different materials may be superimposed. Likewise, the composition of a layer may be graded throughout its thickness. While the coating is generally applied to the piston pins, it may additionally or alternatively be applied to the journal portion of the connecting rod which contacts the pin.

In a preferred coating process, a standard CrN cycle is used with a tight temperature control at low temperatures. Table 1 shows the deposition parameters.

TABLE 1
A typical run sheet for pins cycle

| | | Substrate | | | Gas Flow | | |
|---|---|---|---|---|---|---|---|
| | Time | Bias | Cathodes | Temp | (sccm) | | Press. |
| Phase | (Min) | Volt | Amp | (° F.) | N₂ | Ar | (mTorr) |
| Bombard- | 5 | 1000 | 50 | 400 | | 25 | |
| ment | | | | | | | |
| Coating | 50 | 150 | 60 | 460 | 245 | | 15 |

Coating: CrN
Load: Coupon and pins

The pins are coated in an IonBond's standard computer controlled PVD3344 Q-system labeled P115. The system is equipped with nine (9), 2.5″ diameter cathodes in helical configuration. Following pump down, the system was baked out using radiant heaters at 900° F. for one hour. The base pressure of 2·10⁻⁵ Torr is achieved following the radiant heating step. Then an ion bombardment step follows: the bias voltage was set at (−)1000 volt, and low Ar flow of 25 sccm is introduced. Cathodes are lit one by one to expose the pins to Cr ion bombardment to insure adequate adhesion.

Following the bombardment step the bias voltage is lowered to (−)150 volts and nitrogen is introduced to achieve 15 mTorr pressure for CrN coating deposition. At all times during bombardment and coating the computer program controls the substrate temperature as not to exceed 475° F. The control is done by decreasing the number of working evaporators, while insuring uniform coating coverage. In another version of the coating a 0.5 μm thick chrome under-layer was applied prior to CrN deposition.

Table 2 shows the measured coating properties from a M2 high-speed steel coupon. The coating thickness on the M2 coupon was measured via ball-crater; adhesion was measured by Mercedes and Scratch test; coating roughness—Ra—was measured by surface profilometer.

TABLE 2
Coating Properties

| | | | Adhesion | |
|---|---|---|---|---|
| | | Roughness | Mercedez | |
| | | on | Test | UCL on M2 |
| Cycle Run | Thickness by ball | M2 Coupon | (% | Coupon |
| No. | crater (μm) | (Ra, Å) | Spalling) | (N) |
| 021007-1 | 5.4 | 720 | 0 | 53 |
| 021008-1 | 5.5 | 830 | 0 | 58 |

While the invention has been described with specific reference to piston pins, other portions of an internal combustion engine subject to high temperatures and pressures may also be advantageously coated with the materials of the present invention. Furthermore, structures other than internal combustion engines will also benefit from the use of the coatings of the present invention. Therefore, it is to be understood that the foregoing discussion and description are illustrative of specific embodiments of the invention but are not meant to be limitations upon the practice thereof. It is the following claims, including all equivalents, which define the scope of the invention.

1. A piston pin having a low friction coating thereupon, said coating comprising:
a vapor deposited coating of a compound of a metal, said compound being selected from the group consisting of: carbides, nitrides, oxynitrides, carbonitrides, sulfides, and mixtures thereof.

2. The piston pin of claim 1, wherein said metal is a group IVA-VIA metal.

3. The piston pin of claim 1, wherein said metal is chromium.

4. The piston pin of claim 1, wherein said vapor deposited coating is a coating of chromium nitride.

5. The piston pin of claim 1, wherein said vapor deposited coating is polished.

6. The piston pin of claim 1 wherein the coating is deposited as a plurality of layers.

7. The piston pin of claim 1 wherein the coating is formed a plurality of layers of different compounds selected from the group consisting of carbides, nitrides, oxynitrides, carbonitrides, sulfides, and mixtures thereof.

8. The piston pin of claim 1, wherein said vapor deposited coating is a coating which is deposited by a process selected from the group consisting of: physical vapor deposition, chemical vapor deposition, evaporation, plasma assisted chemical vapor deposition, arc vapor deposition, and combinations thereof.

9. A piston assembly for an internal combustion engine of the type in which a piston is connected to a connecting rod by means of a piston pin, wherein the improvement comprises:
at least a portion of one of said piston pin and connecting rod being coated with a vapor deposited coating of a compound of a metal, said compound being selected from the group consisting of: carbides, nitrides, oxynitrides, carbonitrides, sulfides, and mixtures thereof.

10. The piston assembly of claim 9, wherein said metal is a group IVA-VIA metal.

11. The piston assembly of claim 9, wherein said compound is chromium nitride.

12. The piston assembly of claim 9, wherein said coating is a polished coating.

13. The piston assembly of claim 9 wherein the coating is deposited as a plurality of layers.

14. The piston assembly of claim 9 wherein the coating is formed a plurality of layers of different compounds selected from the group consisting of carbides, nitrides, oxynitrides, carbonitrides, sulfides, and mixtures thereof.

15. An internal combustion engine wherein at least a portion of a component thereof which is in sliding contact with another component thereof is coated with a vapor deposited coating comprised of a compound of a metal, said compound being selected from the group consisting of: carbides, nitrides, oxynitrides, carbonitrides, sulfides, and mixtures thereof.

16. A method for decreasing friction in an internal combustion engine, said method comprising coating at least a portion of a surface of one component thereof, which is in sliding contact with another component thereof, with a vapor deposited coating comprising a compound of a metal, said compound being selected from the group consisting of carbides, nitrides, oxynitrides, carbonitrides, sulfides, and mixtures thereof.

17. The method of claim 16, wherein said step of coating at least a portion of a surface of a component comprises coating said at least a portion of said surface in a vapor deposition process.

18. The method of claim 17, wherein said vapor deposition process is selected from the group consisting of physical vapor deposition, chemical vapor deposition, evaporation, plasma assisted chemical vapor deposition, arc vapor deposition, and combinations thereof.

19. The method of claim 16, wherein said component comprises a piston pin.

20. The method of claim 16, wherein said component comprises a connecting rod.
